(19) United States
(12) Patent Application Publication
(10) Pub. No.: US 2002/0178981 A1
(43) Pub. Date: Dec. 5, 2002

(54) Variable rate drive

(75) Inventors: Paul E. Drummond, Minneapolis, KS (US); Colin D. Christy, Salina, KS (US); Eric D. Lund, Salina, KS (US)

Correspondence Address: Michael J. Gross, SHOOK, HARDY & BACON L.L.P., 1200 Main Street, Kansas City, MO, 64105-2118, US

(73) Assignee: KEJR, Inc.

(21) Appl. No.: 09/870,174

(22) Filed: May 30, 2001

(51) Int. Cl. A01C 15/00

(52) U.S. Cl. 111/903; 111/200; 172/105; 222/52

(57) ABSTRACT

A drive apparatus has a first and second shaft rotatably mounted on the agricultural fertilizer implement. A drive wheel is fixed to the first shaft and an output wheel fixed to the second shaft. There are a plurality of wheels coupled to the first shaft and a plurality of wheels of varying sized fixed to the second shaft. A flexible connecting means is trained between a pair of selected wheels on the first and second shafts. A drive means rotates the drive wheel. A connecting means couples output wheel to the metering device. An engaging means is coupled to each of the plurality of wheels located on the first shaft coupling the selected wheel on the first shaft with the first shaft so that the wheel will rotate with the first shaft. There is also a control means that allows a user to selectively activate one of the engaging means located on the first shaft. When one of the engaging means is activated, one of the plurality of wheels is coupled to the first shaft and begins to rotate with the first shaft. The corresponding wheel located on the second shaft, coupled to the wheel on the first shaft by the flexible connecting means, begins to rotate the second shaft. The output wheel begins to rotate with the second shaft and transfers power to the metering device which regulates the amount of fertilizer dispersed from the implement.

### STATEMENT REGARDING FEDERALLY SPONSORED RESEARCH OR DEVELOPMENT

Not Applicable.

### CROSS-REFERENCE TO RELATED APPLICATIONS

Not Applicable.

### FIELD OF INVENTION

The present invention relates to a variable rate drive apparatus. More specifically, the present invention relates to a variable rate drive apparatus for use on an agricultural planter or fertilizer applicator that allows a user to change the rate in which seed or fertilizer is applied by the agricultural implement.

### BACKGROUND OF THE INVENTION

Most agricultural planters and fertilizer applicators are equipped with a drive apparatus that regulates the speed at which seed or fertilizer is dispersed by an application meter. The amount of seed or fertilizer that needs to be applied varies depending on the type of crops or fertilizer being used, the soil characteristics, and the topography, and any other factors that impact yield potential.

Most seed or fertilizer applicators are not designed to be adjusted during planting. Instead, the seed or fertilizer is distributed at a fixed rate when being applied over the whole field. Since the operator would have to dismount the tractor in order to change the application, the application rate is rarely changed from its original setting.

In addition, there are several types of devices available for varying the application rate while product is being dispersed by the agricultural implement. One device is a planter population reduction drive unit used to lower plant population on center pivot corners, such as U.S. Pat. No. 4,623,078 to Weeder. This device contains a combination of drive belts, a wrap spring clutch, and an over-running clutch to reduce the rotation of a shaft that drives the planter transmission. However, this drive system only offers two speeds, cannot be turned off while the agricultural implement is in motion, and it cannot receive information from a computer to automatically vary the application rate. Thus, this drive system is not adequate for providing a variety of application rates and will not allow an operator to cease application while the agricultural implement is in motion.

A second device available is a dual speed clutch that offers similar planter reduction capabilities. An example of such a device can be found in U.S. Pat. No. 5,632,212 to Kinze. Specifically, this concept utilizes a dual speed mechanical clutch that includes a plurality of hubs, drive springs, and release sleeves. Electric solenoids control the release sleeves, which in turn engage or disengage the proper hub for two separate drive ratios. This device only offers two drive speeds, cannot be easily modified, and cannot be automatically be controlled by a computer.

A third device available for varying the application rate utilizes a hydraulic motor drive, such as in U.S. Pat. No. 4,230,280 to Rawson. This device requires motor feedback and ground speed signals to adjust the metered output of seed or fertilizer. While a plurality of metering rates are obtained, programming and calibration are significantly more complex than found in a ground-driven system. The system required additional expense and maintenance of a separate ground speed wheel sensor or radar, and requires one or more hydraulic outlets of the tractor to be dedicated to its operation.

A fourth device available uses an automatic control system for controlling the application rates. An example of such a device can be found in U.S. Pat. No. 5,632,212 to Kinze. This device uses a flow meter, flow control valve and a radar interface or drive wheel sensors for liquid application. For dry application, this system uses an encoder on the hydraulic motor shaft, a DC motor driven hydraulic valve, and the speed sensor or radar, Again, the complexity and calibration steps are much more involved than with a ground driven system.

Accordingly, there remains a need for a drive apparatus which overcomes the above drawbacks and deficiencies. More specifically, there remains a need for a ground driven drive apparatus that can operate at more than two speeds. In addition, there remains a need for a drive apparatus that can be controlled via an interface to a computer. The objective of this invention is to solve or substantially reduce the problems normally associated with known prior art drive systems.

### SUMMARY OF THE INVENTION

It is an object of the present invention to provide an improved drive apparatus adapted for an agricultural seed or fertilizer implement.

It is another object of the present invention to provide a drive apparatus which can vary application speeds during the operation of the agricultural implement.

It is still a further object of the present invention to provide a drive apparatus which can be automatically controlled via an interface to a computer.

Yet another object of the present invention is to provide a drive apparatus that can easily adapt to existing ground engaging systems.

According to the present invention, the foregoing and other objects are achieved by a drive apparatus having a first and second shaft rotatably mounted on the agricultural fertilizer implement. A drive wheel is fixed to the first shaft and an output wheel fixed to the second shaft. There are a plurality of wheels coupled to the first shaft and a plurality of wheels of varying sizes fixed to the second shaft. A flexible connecting means is trained between a pair of selected wheels on the first and second shafts. A drive means rotates the drive wheel. A connecting means couples output wheel to the metering device. An engaging means is coupled to each of the plurality of wheels located on the first shaft that can couple the selected wheel on the first shaft with the first shaft so that the wheel will rotate with the first shaft. There is also a control means that allows a user to selectively activate one of the engaging means located on the first shaft. When one of the engaging means is activated, one of the plurality of wheels is coupled to the first shaft and begins to rotate with the first shaft. The corresponding wheel located on the second shaft, coupled to the wheel on the first shaft by the flexible connecting means, begins to rotate the second shaft. The output wheel begins to rotate with the second shaft and transfers power to the metering device which applies the fertilizer.

Additional objects of invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means and instrumentalities and combinations particularly pointed out in the appended claims.

### BRIEF DESCRIPTION OF THE DRAWINGS

In the accompanying drawings which form a part of this specification and are to be read in conjunction therewith and in which like reference numerals are used to indicate like parts in the various views:

FIG. 1 is atop perspective view of an agricultural fertilizer implement equipped with the present invention;

FIG. 2 is a fragmentary perspective view of the present invention parts broken away to reveal the inventive gearing system;

FIG. 3 is a front elevational view of the present invention shown in FIG. 2;

FIG. 4 is a right side elevational view of the present invention shown in FIG. 3;

FIG. 5 is a rear elevational view of the present view shown in FIG. 2;

FIG. 6 is an exploded perspective view showing the removable sprocket assembly of the present invention;

FIG. 7 is an illustration view of the control box of the present invention; and

FIG. 8 is a box diagram view illustrative of the control box for the present invention.

### DETAILED DESCRIPTION OF THE PREFERRED EMBODIMENT

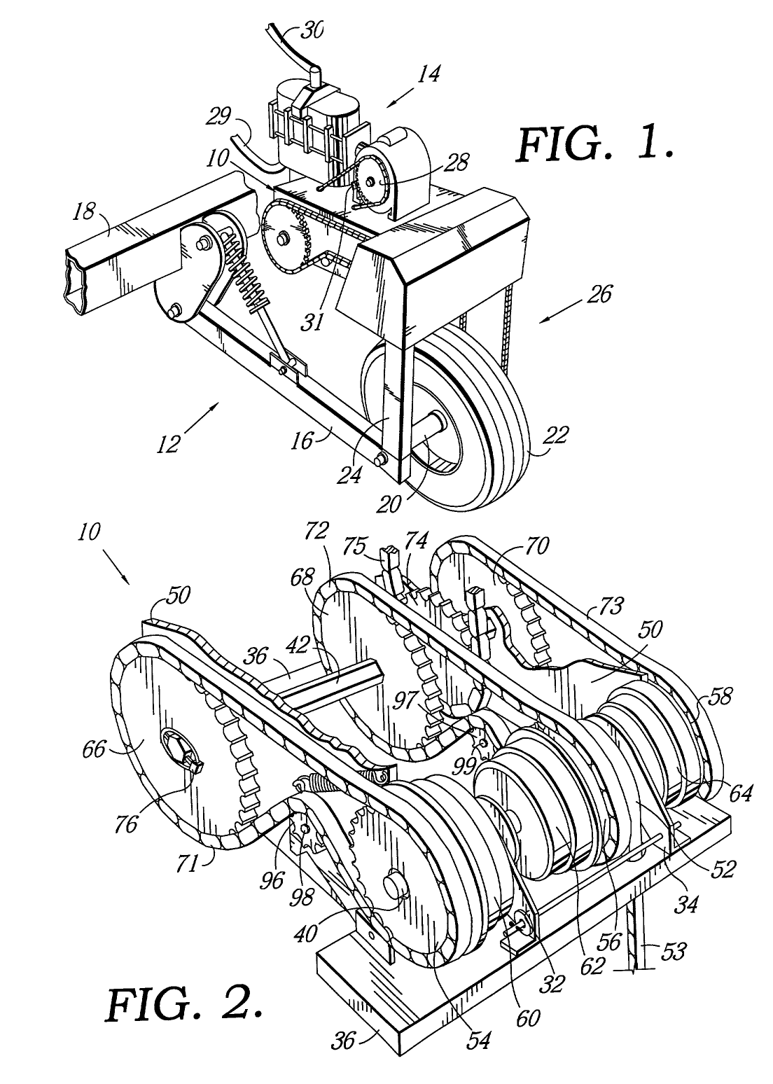

Referring to the drawings in greater detail, and initially to FIG. 1, a drive apparatus embodying the principles of this invention is broadly designated in the drawings by reference numeral 10. Apparatus 10 is used on an agricultural implement 12 to control the rate at which a application meter 14 applies fertilizer over a field. It should, of course, be understood that the drive apparatus of the present invention could be used on an implement to control the rate at which seed is planted or driven into the ground.

Agricultural implement 12 includes support member 16 that is transversely connected to frame 18. Axle 20 is rotatably and transversely mounted on the distal end of support member 16. Ground wheel 22 is rotatably mounted on axle 20. Vertical support 24 is connected to the distal end of support member 16 and extends vertically. Apparatus 10 is coupled to and supported by vertical support 24. Application meter 14 is mounted on the top portion of apparatus 10. Ground wheel 22 drives apparatus 10 indicated generally by 26. Apparatus 10 operates to drive a pump sprocket 28 mounted on application meter 14. As application meter 14 is driven by apparatus 10, fertilizer moves from reservoir, not shown, through input hose 29 and into application meter 14. Application meter 14 regulates the amount of fertilizer to be distributed, and the fertilizer then moves through output hose 30 and onto the field. Sensor 31 monitors the rate at which application meter 14 is distributing fertilizer.

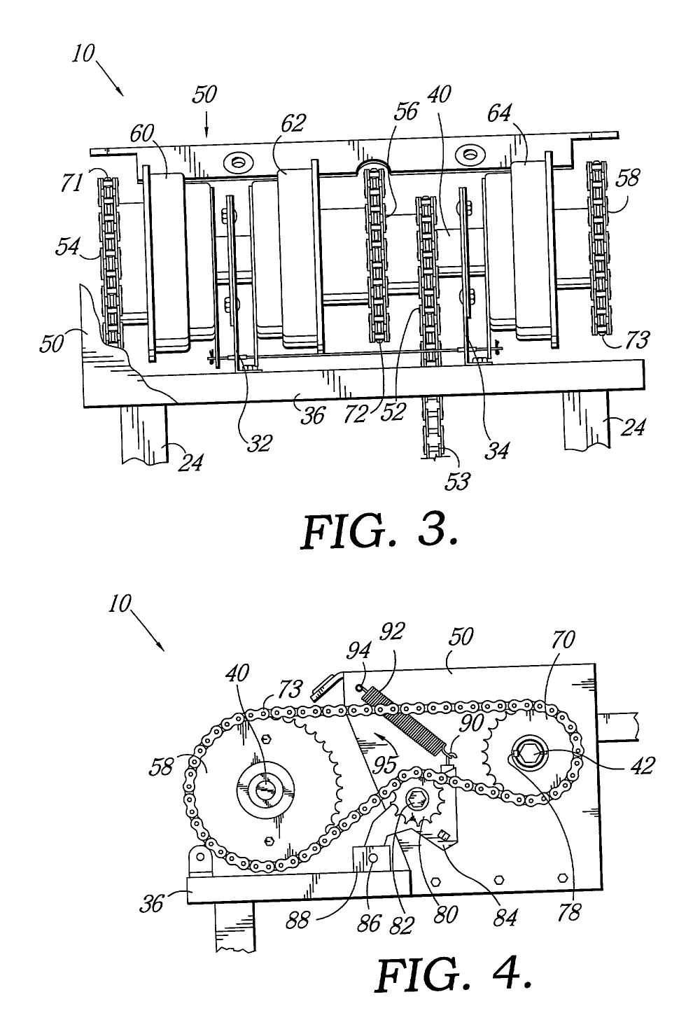

As best seen in FIGS. 2 and 3, flanges 32 and 34 extend vertically from the top portion of horizontal plate 36. First shaft 40 is rotatably mounted on flanges 32 and 34. An apparatus shell 50 is mounted on the sides of horizontal plate 36 and extends vertically therefrom. Second shaft 42 is rotatably mounted on apparatus shell 50 and is parallel to first shaft 40. Drive sprocket 52 is fixedly coupled to first shaft 40, such that when drive sprocket 52 rotates, first shaft 40 rotates therewith. Drive chain 53 transfers power from the ground wheel 22 to the drive sprocket 52. Sprockets 54, 56 and 58 are rotatably mounted to first shaft 40 and are preferably the same size. In addition, electromagnetic clutches 60, 62 and 64 are mounted to first shaft 40. Electromagnetic clutch 60 is coupled to sprocket 54, clutch 62 is coupled to sprocket 56, and electromagnetic clutch 64 is coupled to sprocket 58. When clutch 60, 62, or 64 is activated, clutch 60, 62, or 64 is fixedly coupled to the corresponding sprocket 54, 56, or 58 respectively. This allows sprocket 54, 56, or 58 to rotate with first shaft 40, thereby rotating corresponding sprockets 66, 68, or 70 by chains 71, 72, or 73 respectively.

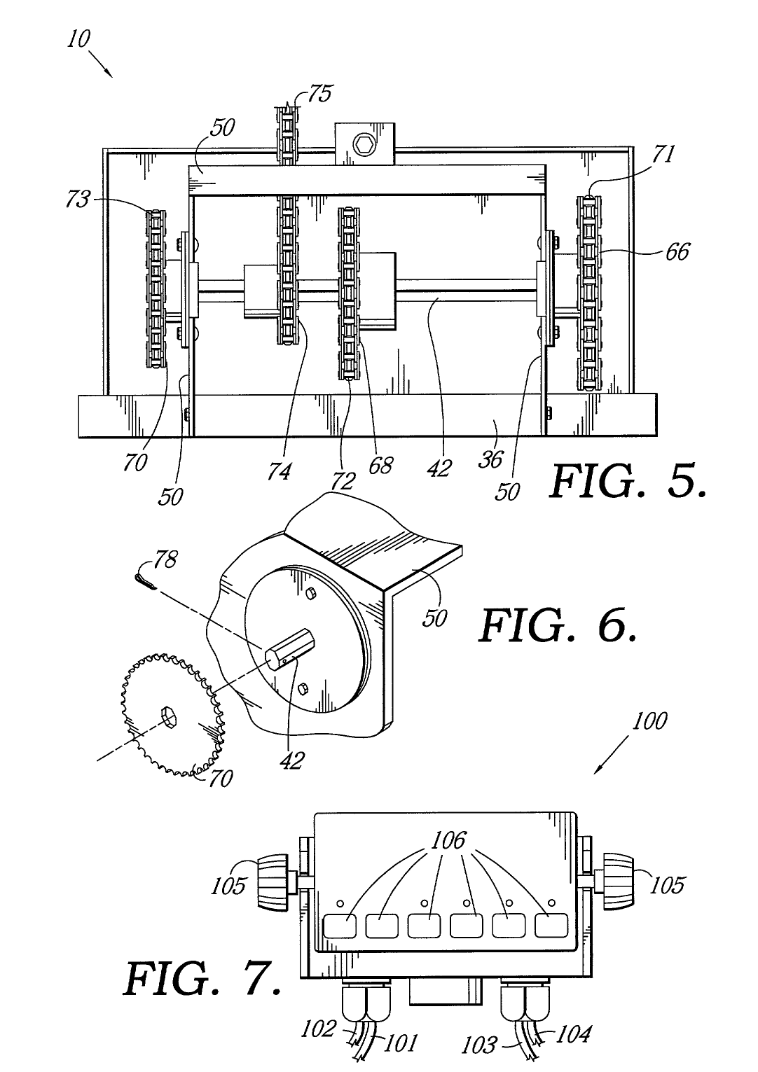

With reference to FIGS. 2, 4, and 5, output sprocket 74 is fixedly coupled to second shaft 42, such that when second shaft 42 rotates, output sprocket 74 rotates therewith. An output chain 75 transfers power from the output sprocket 74 to the application meter 14. Sprockets 66 and 70 are removably and fixedly coupled to second shaft 42 by clips 76 and 78. Sprocket 68 is fixedly coupled to second shaft 42 and cannot be removed. Linking chains 71, 72, and 73 are trained about sprockets 54 and 66, 56 and 68, 58 and 70 respectively.

With reference to FIG. 4, idler sprocket 80 is rotatably mounted to intermediate axle 82. Intermediate axle 82 is rotatably mounted to rotating plate 84. Rotating plate 84 is pivotally mounted to axle 86, which is coupled to vertical brace 88. Vertical brace 88 is mounted on horizontal plate 36. Hook 90 is coupled to rotating plate 84. Spring 92 is mounted to apparatus shell 50 by a pin or fastening mechanism 94. Spring 92 is removably coupled to hook 90 biasing idler sprocket 80 in direction 95 to keep chain 73 tightly trained about sprockets 58 and 70. Idler sprockets 96, 97 and intermediate axles 98, 99 operate in the same fashion as idler sprocket 80 as described above.

As seen in FIG. 7, controller 100 is connected to power wire 101, serial input wire 102, sensor wire 103 and electromagnetic connection wire 104. Electromagnetic connection wire 104 connects controller 100 with electromagnet clutches 60, 62 and 64. Controller 100 is typically mounted in the cab of the vehicle that pulls agricultural fertilizer implement 12 so the user can remotely control the operation of apparatus 10. A pair of knobs 105 are used to angle control 100 to a user selected position for access to the control buttons 106.

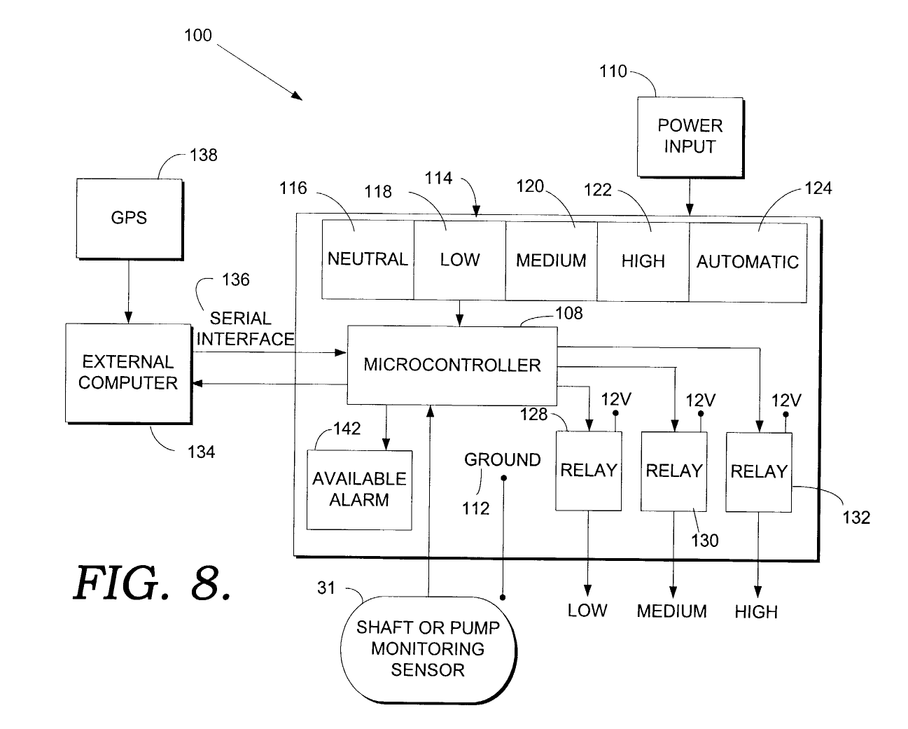

With reference to FIG. 8, controller 100 includes a micro-controller 108 having a power input 110 and ground 112. Micro-controller 108 accepts commands from a user selection panel 114, which includes neutral button 116, low button 118, medium button 120, high button 122, and automatic button 124. Micro-controller 108 has the capability of sending a signal to one of three relays 128, 130, and 132 depending on which button is selected. Relays 128, 130, and 132 are connected to electromagnetic clutches 60, 62, and 64 respectively. The button selected on the panel 114 will determine which clutch is activated 60, 62, or 64, and thus the speed at which the apparatus 10 will operate. Neutral button 116 commands micro-controller 108 not to activate any of the relays 128, 130, or 132. None of the clutches 60, 62, and 64 will be engaged, and there will be no application of fertilizer.

Micro-controller 108 contains internal software and a serial cable input to allow the use of computer controlling software. Micro-controller 108 can be connected to an external computer 134 via a serial interface 136. In addition, Global Positioning System (GPS) 138 can be connected to external computer 134 identifying the location of apparatus 10.

Sensor 31 is coupled to application meter 14 and adjacent to pump sprocket 28. Sensor 31 is used to monitor the speed at which pump sprocket 28 is rotating and sends that information to micro-controller 108 through sensor wire 103. If pump sprocket 28 is rotating at a speed that does not correspond with the button that is selected on panel 114, then the micro-controller 108 will activate alarm 142 to notify the user that apparatus 10 is not operating at the speed selected on panel 114.

In operation, ground wheel 22 moves along the ground transferring drive power 26 to drive sprocket 52 via drive chain 53. As drive sprocket 52 rotates, first shaft 40 also rotates because drive sprocket 52 and first shaft 40 are fixedly coupled to one another. At this point, 20 sprockets 54, 56, and 58 are not rotating because they are rotatably mounted to first shaft 40 and none of electromagnetic clutches 60, 62, or 64 are engaged.

The user operates apparatus 10 by controller 100 that is mounted in the cab of the vehicle that pulls agricultural fertilizer implement 12. The user then selects one of the speeds on the selection panel 114. For example, if the user selects the neutral button 116, a signal is transmitted to the micro-controller 108 telling it not to activate relays 128, 130, and 132. Since none of the relays are activated, none of the electromagnetic clutches 60, 62, or 64 engage shaft 40 with sprockets 54, 56, or 58. Thus, no power is transferred from first shaft 40 to second shaft 42 and application meter is not applying fertilizer.

Alternatively, if the user selects the low button 118 on selection panel 114, a signal is transmitted to the micro-controller 108 telling it to activate relay 128. When relay 128 is activated, clutch 60 engages shaft 40 with sprocket 54 allowing sprocket 54 to rotate with first shaft 40. As sprocket 54 rotates, it drives chain 71 and causes sprocket 66 to rotate. The rotation of sprocket 66 causes second shaft 42 to rotate because they are fixedly coupled to each other. Second shaft 42 then rotates output sprocket 74, drives output chain 75, and provides power to application meter 14. The ratios between sprockets located on first 40 and second 42 shafts will determine the rate at which fertilizer is distributed by application meter 14.

In addition, if the user wants to change the speed at which fertilizer is distributed to the medium rate, the user selects the medium button 120 on selection panel 114. In selecting medium button 120, a signal is transmitted to the micro-controller 108 telling it to deactivate relay 128 and activate relay 130. When relay 128 is deactivated, clutch 60 disengages shaft 40 with 20 sprocket 54 so that sprocket 54 no longer is fixed to first shaft 40, but instead “free wheels” with respect to first shaft 40. When relay 130 is activated, clutch 62 engages shaft 40 with sprocket 56 allowing sprocket 56 to rotate with first shaft 40. As sprocket 56 rotates, it drives chain 72 and causes sprocket 68 to rotate. The rotation of sprocket 68 causes second shaft 42 to rotate because they are fixedly coupled to each other. Second shaft 42 then rotates output sprocket 74, drives output chain 75, and provides power to application meter 14. Since sprocket 68 has a smaller diameter compared to sprocket 66, the fertilizer will be distributed at a medium rate when medium button 120 is activated.

Next, if the user wants to change the speed at which fertilizer is distributed to the highest rate, the user selects the high button 122 on selection panel 114. In selecting high button 122, a signal is transmitted to the micro-controller 108 telling it to deactivate relay 130 and activate relay 132. When relay 130 is deactivated, clutch 62 disengages shaft 40 with sprocket 56 so that sprocket 56 no longer is fixed to first shaft 40, but instead “free wheels” with respect to first shaft 40. When relay 132 is activated, clutch 64 engages shaft 40 with sprocket 58 allowing sprocket 58 to rotate with first shaft 40. As sprocket 58 rotates, it drives chain 73 and causes sprocket 70 to rotate. The rotation of sprocket 70 causes second shaft 42 to rotate because they are fixedly coupled to each other. Second shaft 42 then rotates output sprocket 74, drives output chain 75, and provides power to application meter 14. Since sprocket 70 has a smaller diameter compared to sprocket 68, the fertilizer will be distributed at a higher rate, compared to a low or medium rate, when high button 122 is activated.

Further, if a user selects the automatic button 124, micro-controller 108 receives commands from external computer determining which of the three relays 128, 130, or 132 to 20 activate. The relay selected depends on the position of the implement 12 as determined by GPS 138 and the data stored within external computer 134 regarding desired application rate for that location. Once the external computer determines which relay to activate, if any, apparatus 10 operates in the same fashion as described in the previous two examples but does not require a user to manually select the speed of application.

In addition, chains 71 and 73 can be removed from apparatus 10 for repair, cleaning or to replace sprockets 66 and 70. During the operation of apparatus 10, spring 92 is attached to hook 90 that keeps idler sprocket 80 in the position shown in FIG. 4. When a user wants to remove chains 71 and 73, apparatus 10 must cease operation, and spring 92 is released from hook 90 allowing idler sprocket 80 and rotating plate 84 to pivot about axle 86 and move opposite of direction 95. Chain 73 is then loosened and can be removed from sprockets 58 and 70. Idler sprocket 96 functions in the same fashion as idler sprocket 80 allowing the release of chain 71.

Sprockets 66 and 70 can be removed from second shaft 42 and replaced with different sized sprockets to match a desired sprocket ratio. With reference to FIGS. 4 and 6, clip 78 removably couples sprocket 70 to second shaft 42. After chain 73 is removed from sprockets 58 and 70 as stated above, clip 78 can then be removed from second shaft 42. Sprocket 70 is then released from second shaft 42. Sprocket 66 can be removed and replaced in the same fashion as sprocket 70. This allows a user to replace sprockets 66 or 70 with various sized sprockets to change the gear-ratio with respect to sprockets 54 and 58. The ability to change sprocket-ratios will allow output sprocket 74 to operate at a multitude of user selected speeds. Sprocket 68 is fixedly coupled to second shaft 42 and cannot be replaced.

Constructed and operated as previously described, this invention provides an 20 improved drive apparatus 10 that operates at low, medium, or high speeds. Additionally, apparatus 10 can be placed in neutral that stops fertilizer application. Further, apparatus 10 has an automatic feature that allows an external computer 134 and GPS 138 to maintain a preferred rate of fertilizer application. Still further, as illustrated in FIGS. 1-8, apparatus 10 is compact and self-easily adaptable to existing ground engaging systems.

From the foregoing, it will be seen that this invention is one well-adapted to attain the ends and objects hereinabove set forth together with other advantages which are obvious and inherent to the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in accompanying drawings is to be interpreted as illustrative and not in a limiting sense.

I claim:

1. A variable rate drive apparatus for controlling the amount of product distributed by a meter device of an agricultural implement, said apparatus comprising:
a first rotatably driven shaft;
a first plurality of wheels associated with said first shaft;
a second shaft coupled to and powering the metering device;
a second plurality of wheels associated with said second shaft;
wherein each of said first plurality of wheels is coupled to a corresponding one of said second plurality of wheels to form a wheel pair;
wherein at least one of said wheel pairs offers a different metering speed than another of said wheel pairs; and
wherein at least one of said wheels in at least one of said wheel pairs is associated with a clutch mechanism on said wheels respective shaft to allow an operator to choose which wheel pair will determine the metering speed.

2. The apparatus as recited in claim 1, wherein said first shaft is driven by a ground wheel.

3. The apparatus as recited in claim 1, wherein said second shaft is coupled to and powers the metering device by a chain and sprocket.

4. The apparatus as recited in claim 1, wherein said clutch mechanism is an electromagnetic clutch.

5. The apparatus as recited in claim 1, wherein said second plurality of wheels associated with said second shaft are removably mounted to said second shaft.

6. The apparatus as recited in claim 1, further comprising a control means, wherein said control means is adapted to accept commands from the user or an external computer.

7. The apparatus as recited in claim 6, wherein said external computer uses GPS for determining the location of the apparatus and said external computer provides information regarding the desired application rate of the product for that location.

8. The apparatus as recited in claim 6, wherein said control means permits a user to select which engagement means to activate, thereby determining the rate at which the metering device will operate, choose not to activate the engagement means, thereby stopping the operation of the metering device, or choose an automatic function that enables said control means to receive commands from said external computer that automatically activates the engagement means, if at all, based on the location and desired application rate.

9. The apparatus as recited in claim 6, wherein said control means includes an alarm, wherein said alarm notifies a user if the metering device is not operating at the speed selected by the user or the external computer.

10. The apparatus as recited in claim 1, wherein first and second plurality of wheels are sprockets, wherein each of said first plurality of sprockets is coupled to a corresponding one of said second plurality of sprockets by a chain.

11. A variable rate drive apparatus for controlling the amount of product distributed by a meter device of an agricultural implement, said apparatus comprising:
a first rotatably driven shaft;
a first plurality of wheels associated with said first shaft;
a second shaft coupled to and powering the metering device;
a second plurality of wheels associated with said second shaft;
wherein each of said first plurality of wheels is coupled to a corresponding one of said second plurality of wheels to form a wheel pair;
wherein at least one of said wheel pairs offers a different metering speed than another of said wheel pairs; and
wherein at least one of said wheels in at least one of said wheel pairs is associated with a clutch mechanism on said wheels respective shaft to allow an operator to choose which wheel pair will determine the metering speed.

12. The apparatus as recited in claim 11, wherein said first shaft is driven by a ground wheel.

13. The apparatus as recited in claim 11, wherein said second shaft is coupled to and powers the metering device by a chain and sprocket.

14. The apparatus as recited in claim 11, wherein said engaging means is an electromagnetic clutch.

15. The apparatus as recited in claim 11, wherein said second plurality of wheels associated with said second shaft are removably mounted to said second shaft.

16. The apparatus as recited in claim 11, further comprising a control means, wherein said control means is adapted to accept commands from the user or an external computer.

17. The apparatus as recited in claim 16, wherein said external computer uses GPS for determining the location of the apparatus and said external computer provides information regarding the desired application rate of the product for that location.

18. The apparatus as recited in claim 16, wherein said control means permits a user to select which engagement means to activate, thereby determining the rate at which the metering device will operate, choose not to activate the engagement means, thereby stopping the operation of the metering device, or choose an automatic function that enables said control means to receive commands from said external computer that automatically activates the engagement means, if at all, based on the location and desired application rate.

19. The apparatus as recited in claim 16, wherein said control means includes an alarm, wherein said alarm notifies a user if the metering device is not operating at the speed selected by the user or the external computer.

20. The apparatus as recited in claim 11, wherein first and second plurality of wheels are sprockets, wherein each of said first plurality of sprockets is coupled to a corresponding one of said second plurality of sprockets by a chain.

21. An application system for applying an agricultural product, said system comprising:
a metering device;
a first shaft coupled to said metering device;
drive means;
a second shaft coupled to drive means;
a plurality of wheel pair means coupling said first and second shafts, at least one of said wheel pair means offering a different metering speed than another of said wheel pair means; and
engaging means for selecting which of said wheel pair means transfers power between said first and second shaft.

22. The apparatus as recited in claim 21, wherein said plurality of wheel pair means include sprockets coupling first and second shafts by chains.

23. The apparatus as recited in claim 21, wherein said engaging means includes an electromagnetic clutch.

24. The apparatus as recited in claim 21, wherein said drive means includes a ground driven wheel.
